(19) United States
(12) Patent Application Publication
(10) Pub. No.: US 2020/0251903 A1
(43) Pub. Date: Aug. 6, 2020

(54) Distributed Energy Storage

(71) Applicant: John Matthew Confrey, Coto de Caza, CA (US)

(72) Inventor: John Matthew Confrey, Coto de Caza, CA (US)

(21) Appl. No.: 16/268,301

(22) Filed: Feb. 5, 2019

(51) Int. Cl. H02J 3/32; H02J 7/00

(52) U.S. Cl. CPC H02J 3/32; H02J 7/0013

(57) ABSTRACT

A distributed energy storage system is either integrated within or collocated with the equipment and systems that use the most electrical power in residential or commercial facilities for the purpose of time shifting the electrical load from peak to off-peak hours. The time shift of the electrical power demand makes renewable energy generation more cost effective and it reduces the electrical power costs for consumers who have higher rates for peak period electrical consumption, or who have demand charges for peak usage.

### FIELD OF THE INVENTIONS

The inventions described below relate to the field of distributed energy storage.

### BACKGROUND OF THE INVENTIONS

Renewable energy generation techniques such as wind and solar do not always provide maximum power generation when the utility grid needs it. Consequently, renewable energy generation is struggling to penetrate the U.S. energy market.

### SUMMARY

The devices and methods described below provide for distributed energy storage either integrated within or collocated with the equipment and systems that use the most electrical power in residential or commercial facilities for the purpose of time shifting the electrical load from peak to off-peak hours. The time shift of the electrical power demand makes renewable energy generation more cost effective and it reduces the electrical power costs for consumers who have higher rates for peak period electrical consumption, or who have demand charges for peak usage.

The systems and equipment that include the energy storage will be integrated within or collocated with any suitable residential or commercial systems that use electrical energy. This includes systems such as:
HVAC, space cooling and conditioning systems, such as air conditioner or chiller systems including but not limited to unitary air conditioning systems, mini splits, portable air conditioners, packaged terminal air conditioner systems, window/wall units, heat pumps, chillers and variable refrigerant flow systems;
Electric water heating systems including but not limited to tank, tankless and heat pump types;
Refrigeration systems;
Lighting systems including lamps, bulbs, luminaires, drivers, fittings, fixtures, receptacles, ballasts, controllers and wall switches.

### BRIEF DESCRIPTION OF THE DRAWINGS

FIG. 1 is a side view of an electric switch with an integrated energy storage system.

FIG. 2 is a front view of an electric light with integrated energy storage system.

FIG. 3 is a front view of an electric light socket with integrated energy storage system.

FIG. 4 is a perspective view of a refrigerator with integrated energy storage system and collocated energy storage system.

FIG. 5 is a perspective view of an electric water heater with integrated energy storage system.

FIG. 6 is a perspective view of a tankless water heater with integrated energy storage system.

FIG. 7 is a block diagram of an HVAC system with integrated energy storage system.

FIG. 8 is a perspective view of an air conditioner with collocated energy storage system.

### DETAILED DESCRIPTION OF THE INVENTIONS

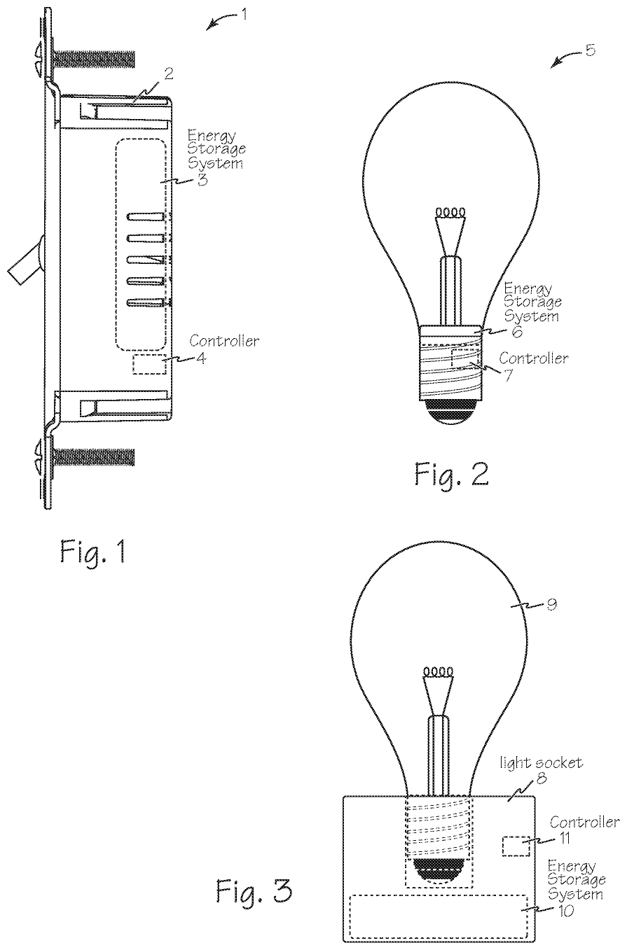

A wall switch 1 for applying electrical power is illustrated in FIG. 1. The switch 1 has a housing or case 2 that encloses a suitable energy storage system 3 along with a control system 4. The energy storage system 3 may use any suitable technology such as batteries for integrated energy storage and collocated storage may also use any suitable batteries and may also adopt more sophisticated techniques such as storing the energy as hydrogen or as thermal energy that may be utilized during off peak hours.

The control system 4 includes the ability to be programmed to control the charging and use of the power from the energy storage system 3. For example, the peak and off peak hours for local energy usage may be programmed into the controller so that the energy storage system 3 will charge during off peak hours, and the cooling, water heating, refrigeration or lighting equipment connected to the switch will preferentially draw operating power from the energy storage system during peak hours. The control system 4 may also include the ability to be programmed with peak and off peak seasons, most notably for cooling systems, so that if there is a part of the year during which the cooling system is not likely to be used, the energy storage system can be utilized by other systems in the building, property or the power grid or if not otherwise used, the system can be designed to optimize charge and discharge cycles to promote and extend the useful life of the energy storage system.

The control systems may optionally integrate the following:
Communication and integration with other distributed energy storage systems within the same building or complex for optimal cooperation and charge/discharge patterns;
Integration with a solar photovoltaic system to optimize use of renewable energy over utility supplied power;
Smart thermostat capabilities including pre-programmed settings for different times of the day and for when people are or aren't likely to be in the building;
Internet of Things (IoT) capability for remote control of systems;
Operation as a backup power source for the building in the case of a power outage;
Operation with smart grid systems to optimize use of stored power to optimize overall grid efficiency, stability, sustainability and reliability;
Communication and integration with building Environmental Monitoring Systems (EMS) and Building Management Systems (BMS);
Communication with the electric power generation utility to be utilized as a distributed power asset when the utility deems it is needed.

The present distributed energy storage system differs from a whole home or whole building energy storage system in that the distributed system preferentially provides power to specific priority systems. For example, lighting or a refrigerator would last longer during a power outage with dedicated battery energy storage than if the energy storage was shared with other less important loads. When the present distributed energy storage system is used for reduction of peak power costs, an air conditioning system would be able to run for a longer period on stored “off peak” power if the power wasn't being shared with other electrical equipment in the home or building.

A light with integrated electrical energy storage is illustrated in FIG. 2. The light 5 includes an integrated energy storage system 6 and an energy controller 7. Under the control of the energy controller 7 the energy storage system 6 stores energy during the off-peak periods and provides the stored energy to the light 5 during peak periods to lessen the energy demand from the grid. Any suitable lighting components such as lamps, bulbs, luminaires, drivers, fittings, fixtures, receptacles, ballasts, controllers may include or be connected to distributed energy storage as disclosed herein.

FIG. 3 is a front view of an electric light socket 8 with integrated electrical energy storage. In this configuration the light 9 is a conventional light and the socket 8 contains the energy storage system 10 and an energy controller 11.

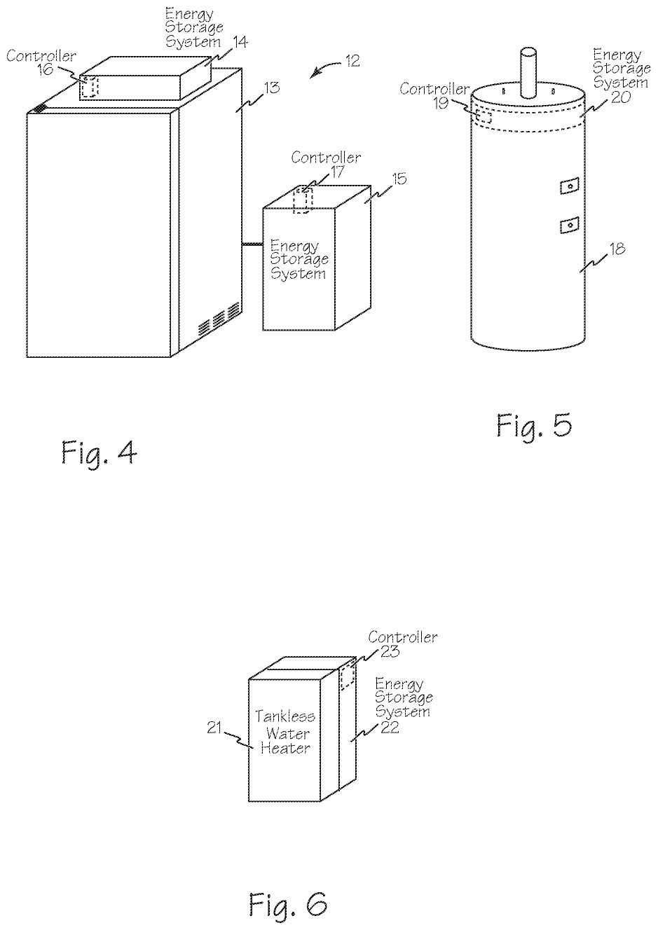

FIG. 4 is a perspective view of a refrigerator system 12 which includes a refrigerator 13 with both an integrated energy storage 14 and collocated energy storage system 15. The integrated energy storage system 14 includes energy controller 16 and collocated energy storage system 15 includes energy controller 17. Large consumers of electricity may incorporate either or both integrated and or collocated energy storage.

FIG. 5 is a perspective view of an electric water heater 18 with integrated energy controller 19 and energy storage system 20. Similarly, FIG. 6 is a perspective view of a tankless water heater 21 with integrated electrical energy storage system 22 and energy controller 23.

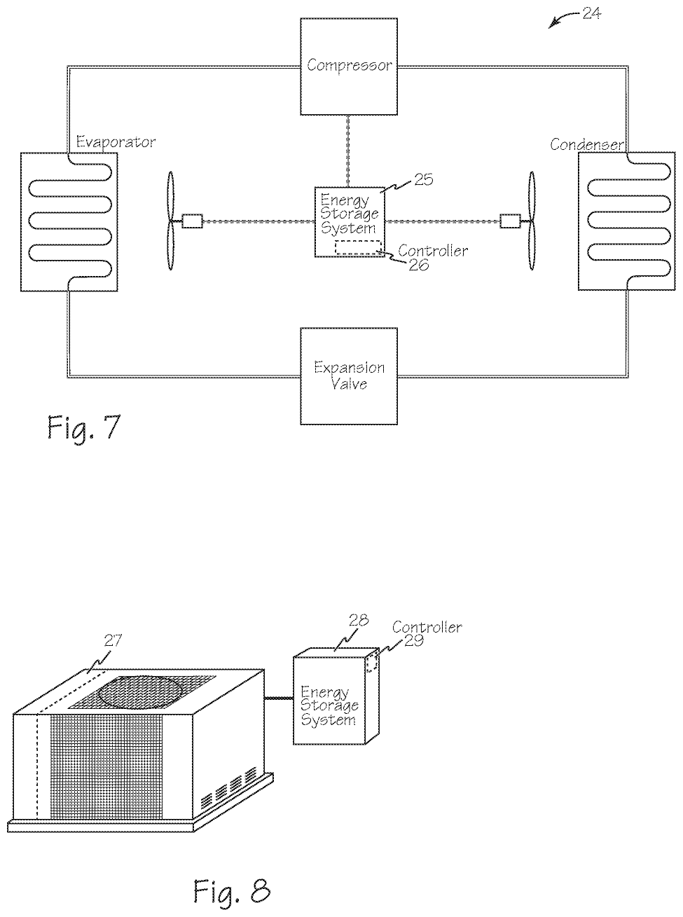

FIG. 7 is a block diagram of an HVAC system 24 with an energy storage system 25 and energy controller 26. The energy storage system 25 may be integrated within any portion or portions of the HVAC system or collocated with one or more elements of the HVAC system as illustrated in FIG. 8. The HVAC compressor/condenser unit 27 of FIG. 8 is operatively connected to a collocated energy storage system 28 and energy controller 29.

Another option would be to apply the distributed energy storage systems to DC cooling, water heating, refrigeration and lighting systems for the purposes of eliminating one or multiple inverter systems within the battery energy storage system or on a solar photovoltaic generation system, which reduce the overall costs of the system.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A distributed energy storage system comprising:
one or more systems that use energy selected from the group consisting of air conditioning systems, mini splits, portable air conditioners, packaged terminal air conditioner systems, window/wall air conditioning units, heat pumps, chillers and variable refrigerant flow systems, electric water heating systems, heat pumps, refrigeration systems, lamps, bulbs, luminaires, drivers, fittings, fixtures, receptacles, ballasts, controllers and wall switches;
an energy storage system with an energy controller operatively connected to each of the one or more systems that use energy.

2. The distributed energy storage system of claim 1 wherein the energy storage systems and energy controllers are integrated into each of the one or more systems that use energy.

3. The distributed energy storage system of claim 1 wherein the energy storage systems and energy controllers are collocated with and operatively connected to each of the one or more systems that use energy.

4. The distributed energy storage system of claim 1 wherein each energy controller is operable to control the charging and use of the power from the energy storage system.

5. The distributed energy storage system of claim 1 wherein each energy controller is operable to control the energy storage system to charge the energy storage system during off peak hours and preferentially provide operating power from the energy storage system to the operably connected systems that use energy during peak hours.

6. The distributed energy storage system of claim 5 wherein each energy controller is operable to control the energy storage system to charge the energy storage system during off peak hours and preferentially provide operating power from the energy storage system to any operably connected systems that use energy during peak hours.

7. The distributed energy storage system of claim 1 wherein each energy controller is operable to control the energy storage system to charge the energy storage system during off peak seasons and preferentially provide operating power from the energy storage system to any operably connected systems that use energy during the off peak seasons.
